(19) United States
(12) Patent Application Publication
(10) Pub. No.: US 2010/0033758 A1
(43) Pub. Date: Feb. 11, 2010

(54) IMAGE FORMING SYSTEM AND IMAGE FORMING METHOD

(75) Inventor: Tamotsu SAKURABA, Sagamihara-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/506,432

(22) Filed: Jul. 21, 2009

(30) Foreign Application Priority Data
Aug. 6, 2008 (JP) 2008-202480

(51) Int. Cl. G06F 15/00

(52) U.S. Cl. 358/1.15

(57) ABSTRACT

An image forming system wherein, when there is an instruction to print a plurality of copies of the same image, a plurality of copies to be printed are allocated to each of a plurality of printers and distributed printing is performed, with this image forming system including a distributed print control device wherein, if it has been determined that confirmation printing in which each of a plurality of image forming apparatus prints only one copy cannot be performed normally in at least one of the printers, a plurality of copies to be printed are allocated to each of the printers having been determined to have performed normal confirmation printing, out of a plurality of printers, whereby distributed printing is performed.

This application is based on Japanese Patent Application No. 2008-202480 filed on Aug. 6, 2008 in Japanese Patent Office, the entire content of which is hereby incorporated by reference.

### BACKGROUND OF THE INVENTION

The present invention relates to an image forming system and method in which when an instruction has been given to print a plurality of copies, the operations of printing the plurality of copies are allocated to a plurality of image forming apparatuses for example, whereby distributed printing is performed.

In one of the conventionally known image forming apparatuses, in response to the instruction from a client PC (Personal Computer), a plurality of copies of printed matters are allocated to a plurality of color digital photocopiers, whereby distributed printing is performed (Refer to Japanese Unexamined Patent Application Publication No. 2002-111917). This image forming system can be switched between two modes which are a single printing mode wherein printing is performed by one color digital photocopier, and a distributed printing mode wherein printing is performed by a plurality of color digital photocopiers.

This image forming system further allows selection among the Bosch mode, best mode and custom mode in the distributed printing operation. The Bosch mode provides uniform allotment of the number of prints among a plurality of color digital photocopiers. In the best mode, the number of prints is allotted to each of a plurality of color digital photocopiers with consideration given to the performance of the plurality of color digital photocopiers. The custom mode permits the user to set the number of copies for each of a plurality of color digital photocopiers.

In the conventional image forming system, however, if some of the color digital photocopiers fail to perform normal printing operations in the distributed printing operation, normally printed matters cannot be outputted. Then the number of copies of the normally printed matters desired by the user cannot be obtained in the color digital photocopier thereof. This problem is not restricted to the cases where a color digital photocopier is used as a printing machine and the problem is also found in other image forming apparatuses such as a printer.

In view of problems of the prior art described above, it is an object of the present invention to provide an image forming system and method wherein normal printing operation can be performed to output the number of copies desired by a user, even when some of the image forming apparatuses fail to perform normal printing operations in a distributed printing mode.

### SUMMARY

To achieve at least one of the abovementioned objects, an image forming system reflecting one aspect of the present invention comprises the followings.

1. An image forming system which performs distributed printing in which a plurality of copies of printed matters are produced by assigning the plurality of copies to a plurality of image forming apparatuses, the image forming system including a distributed print control device which assigns the plurality of copies to one or more image forming apparatuses which have conducted confirmation printing normally among the plurality of image forming apparatuses so as to perform the distributed printing, when the confirmation printing was not able to be conducted normally on at least one of the plurality of image forming apparatuses as a result of confirmation printing conducted for confirmation of image quality on each of the plurality of image forming apparatuses which are candidates to which the plurality of copies are to be assigned.

2. The image forming system of Item 1, wherein, based on printing speed of each of the one or more image forming apparatuses which have completed the confirmation printing normally, the distributed print control device assigns the plurality of copies to the one or more image forming apparatuses in such a way as to assign more copies to a faster image forming apparatus in printing speed, in order of the speed.

3. The image forming system of Item 1, wherein each of the plurality of image forming apparatuses includes an operation section which receives an operation of a user indicating whether or not the confirmation printing has been conducted normally, and wherein the image forming system further includes a display section which displays to indicate that the confirmation printing was normal for an image forming apparatus which has received, by the operation section, the operation of a user indicating that the confirmation printing has been conducted normally, and a distributed print instructing section which conducts distributed printing by assigning the plurality of copies to one or more image forming apparatuses whose confirmation printing is indicated to be normal.

4. The image forming system of Item 3, further including a selecting section for selecting one or more image forming apparatuses to which the plurality of copies are to be assigned so as to conduct distributed printing among the one or more image forming apparatuses whose normality of the confirmation printing is displayed on the display section, wherein the distributed print control device assigns the plurality of copies to the one or more image forming apparatuses selected by the selecting section so as to conduct distributed printing.

5. The image forming system of Item 4, wherein the selecting section is in a situation where the selecting section has selected all the one or more image forming apparatuses whose normality of the confirmation printing is displayed on the display section, at a first stage.

6. The image forming system of Item 1, wherein each of the plurality of image forming apparatuses includes an operation section which receives an operation of a user indicating whether or not the confirmation printing has been conducted normally, wherein when the operation section receives the operation indicating that the confirmation printing has been conducted normally, the system starts printing on an image forming apparatus in order of reception of the operation indicating that the confirmation printing was normal.

7. The image forming system of Item 6, wherein the distributed print control apparatus receives information on a number of copies already printed, from the image forming apparatus which has already started printing, and based on the number of printed copies, the system distributes copies of a remaining number to the one or more image forming apparatuses which received the operation indicating that the confirmation printing has been conducted normally.

8. The image forming system of Item 1, wherein the plurality of image forming apparatuses are connected in a clustering structure having a parallel connection relationship with each other and wherein the distributed print control device is included in the printer controller which gives a printing instruction to each of the plurality of image forming apparatuses connected in the clustering structure.

9. The image forming system of Item 1, wherein the plurality of image forming apparatuses are connected in tandem in which an image forming apparatus to be a parent apparatus and another or other image forming apparatuses are connected in series and wherein the distributed print control device is included in the image forming apparatus to be the parent apparatus connected in tandem.

10. The image forming system of Item 1, wherein the distributed print control device is a server provided on a network.

### BRIEF DESCRIPTION OF THE DRAWINGS

FIG. 1 is a control block diagram showing the overall structure of the image forming system in the first embodiment.

FIG. 2 is a diagram showing an example of a printer driver setting screen.

FIG. 3 is a flow chart showing the image forming method in the first embodiment.

FIG. 4 is a diagram showing an example of display on a display section.

FIG. 5 is a diagram showing another example of display on the display section.

FIG. 6 is a flow chart showing the image forming method in the second embodiment.

FIG. 7 is a flow chart showing the image forming method in the second embodiment.

FIG. 8 is a control block diagram showing the overall structure of the image forming system in the third embodiment.

FIG. 9 is a flow chart showing the image forming method in the third embodiment.

FIG. 10 is a flow chart showing the image forming method in the third embodiment.

FIG. 11 is a flow chart showing another example of the image forming method in the third embodiment.

FIG. 12 is a flow chart showing another example of the image forming method in the third embodiment.

FIG. 13 is a control block diagram showing the overall structure of the image forming system in the fourth embodiment.

### DETAILED DESCRIPTION OF THE PREFERRED EMBODIMENTS

The following describes the present invention with reference to the embodiments of the present invention, without the present invention being restricted thereto. The same or similar components in these embodiments will be assigned with the same reference numerals and will not be described to avoid duplication.

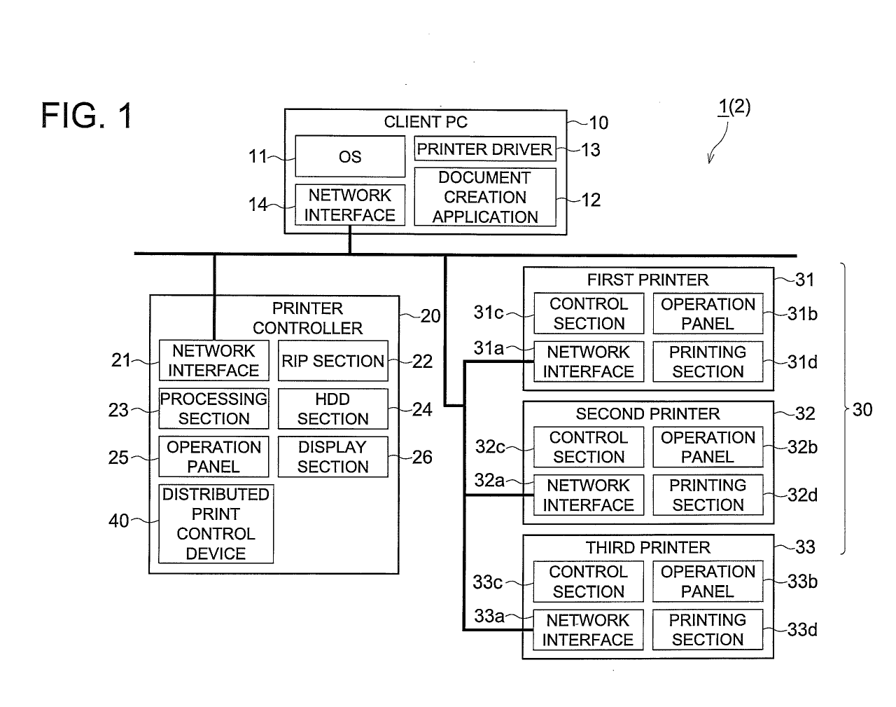

FIG. 1 is a control block diagram showing the overall structure of the image forming system in the first embodiment. The image forming system 1 in this embodiment includes a client PC 10, a printer controller 20 and a plurality of printers 30, which are connected with one another through the Intranet. This image forming system 1 has a function of performing distributed printing operation in which, if there is an instruction to print a plurality of copies in regard to an identical image, the operation of printing a plurality of copies is allocated to a plurality of printers 30. Further, the image forming system 1 has a function of performing the confirmation printing operation to check whether or not normal printing can be performed in each of the printers 30, before distributed printing starts. The following describes the portions shown in FIG. 1.

The client PC 10 permits the user to create documents or receive an instruction to print out the document from the user. This client PC 10 includes an OS (Operating System) 11, a document creation application 12, a printer driver 13 and a network interface 14.

The OS 11 is the software that provides overall management of the client PC 10, and corresponds to the Windows (registered trademark) and Macintosh (registered trademark), for example. The document creation application 12 is the software that permits user to create a document or an image. It corresponds to the Microsoft Office Word or Excel, for instance.

The printer driver 13 receives a printing instruction from the user, and converts the data regarding the document or the image created by the document creation application 12, into the language that can be read by the printer controller 20. Further, the printer driver 13 can also receive an instruction to perform finishing operations such as stapling and punching, an instruction on the number of copies and an instruction to perform distributed printing and confirmation printing. The printer driver 13 also converts the above-mentioned information into the language that can be read by the printer controller 20. The language that can be read by the printer controller 20 may be PDL (Page Description Language) such as PCL (Printer Command Language) and PostScript.

The network interface 14 serves as a connector for connecting the client PC 10 and network. The client PC 10 sends the PDL data converted by the printer driver 13, to the printer controller 20 through the network interface 14.

The printer controller 20 provides instructions to each of or any of a plurality of printers 30 to perform printing operations based on the PDL data from the client PC 10. This printer controller 20 includes a network interface 21, a RIP (Raster Image Processor) section 22, a processing section 23, an HDD (Hard Disk Drive) section 24, an operation panel 25, a display section 26, a printer interface 27 and a distributed print control device 40.

The network interface 21 has a function of serving as a connector to connect the printer controller 20 and network. Further, the network interface 21 serves as a connector to connect the printer controller 20 and a plurality of printers 30 through the network. The RIP section 22 analyzes the PDL data from the client PC 10 and develops into the bitmap data. The processing section 23 analyzes the information on finishing process such as stapling and punching included in the PDL data, and the information on the number of copies. Further, the processing section 23 analyzes the information of the distributed printing and information of the confirmation printing contained in the PDL data. The processing section 23 sends the bitmap data (preferably, compressed bitmap data) developed by the RIP section 22, information on the method of outputting the prints such as the method of stapling and punching, information on the number of copies, and the information on instructions of performing confirmation printing, to each of the printers 30 through the network interface 21. Further, when confirmation printing is specified, the processing section 23 gives an instruction to the printer 30 intended to perform the printing, to print a predetermined number of copies, before allowing the required number of copies to be printed. If distributed printing is specified and confirmation printing is also specified, the processing section 23 gives an instruction to each of the printers 30 to print a predetermined number of copies, before allowing the allocated number of copies to be printed. The predetermined number of copies for confirmation printing can be one or a part of the pages constituting one copy. The image for confirmation printing can be a test image.

The HDD section 24 stores the bitmap data developed by the RIP section 22. The printer controller 20 can include a memory such as a RAM (Random Access Memory) instead of the HDD section 24. The operation panel 25 receives various forms of operations on the printer controller 20. The display section 26 displays the status of the printer controller 20 and information from a plurality of printers 30.

The distributed print control device 40 monitors and controls the state of the distributed printing. To be more specific, if confirmation printing operation cannot be normally performed in at least one printer 30 during the distributed printing, the distributed print control device 28 gives the instruction of distributed printing only to the printers 30 having normally performed the confirmation printing operation. The expression “confirmation printing operation cannot be normally performed” signifies either that the printing output based on the confirmation printing cannot be obtained due to the failure of the printer 30, or that printing output can be obtained based on the confirmation printing, but the user has determined that the image quality has a problem, or others. The following description is based on the assumption of the latter case, which may be expressed simply as “normal confirmation printing”.

The plurality of printers 30 are the image forming apparatuses which perform printing operation in conformance to the information from the printer controller 20. Three printers 30 are shown in FIG. 1, but any number of printers will do if only the number is more than one.

The first printer 31 includes a network interface 31a, operation panel 31b, control section 31c and printing section 31d. The second printer 32 and third printer 33 also include network interfaces 32a and 33a, operation panels 32b and 32c, control sections 32c and 33c, and printing sections 32d and 33d.

The network interfaces 31a through 33c serve as connectors to connect each of printers 30 and printer controller 20 through the network. The operation panels 31b through 33b receive the operation by the user. The control sections 31c through 33c control the printing sections 31d through 33d according to the operation received by the operation panels 31b through 33b. Further, the control sections 31c through 33c control the printing sections 31d through 33d according to the information on the finishing process and the information on the number of copies sent from the printer controller 20. The printing sections 31d through 33d perform printing operations under the control of the control section 31c.

The following describes the overview of the operation of the image forming system 1. In the first place, the user employs the document creation application 12 to create a document to be printed. This document can be created using another client PC.

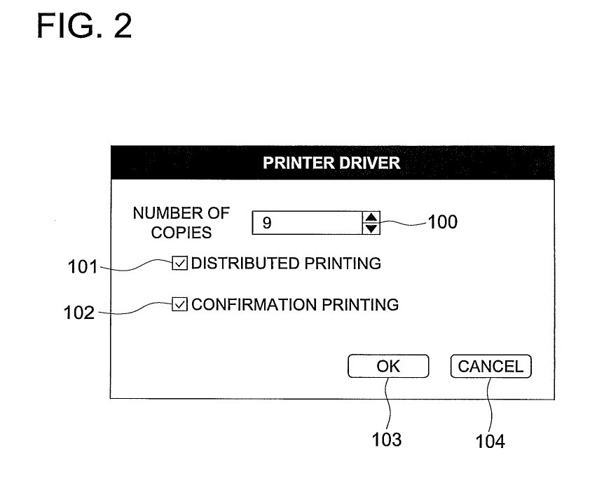

FIG. 2 is a diagram showing an example of the setting screen of the printer driver 13. The user inputs the number of copies on the setting screen after completion of the document. In this case, the user inputs the number of copies into the column 100 for the number of copies on the setting screen in FIG. 2, and checks the check box 101 of the distributed printing. When the user has operated the OK button 103, the printer driver 13 converts the document data into the PDL data. At the same time, the information on the number of copies and the instruction of performing the distributed printing operation are also converted into the PDL data. After that, the client PC 10 sends the PDL data to the printer controller 20 through the network interface 14.

Then the printer controller 20 inputs the PDL data and the RIP section 22 analyzes the PDL data to develop into the bitmap data. The HDD section 24 stores this bitmap data. The processing section 23 analyzes the information on the number of copies and the information that an instruction of the distributed printing has been given.

The processing section 23 allocates the number of copies to a plurality of printers 30. For example, when the number of copies is “9”, the processing section 23 allocates three copies to each of the three printers 30. The printer controller 20 sends the information on the allocated number of copies and bitmap data to each of the first printer 31 through the third printer 33. Each of the printers 30 receives the above-mentioned information through the network interfaces 31a through 33a, and printing sections 31d through 33d print only the allocated number of copies.

If the check box 102 for confirmation printing is checked on the setting screen shown in FIG. 2, the processing section 23 gives a confirmation printing instruction to each of the first printer 31 through the third printer 33. This procedure allows the first printer 31 through the third printer 33 to print only a predetermined number of copies (e.g. one copy). The user checks the predetermined number of printed copies on the first printer 31 through the third printer 33 and determines whether or not normal confirmation printing operation can be performed before distributed printing operation starts.

Particularly in this embodiment, when normal confirmation printing cannot be performed in at least one printer 30, the distributed print control device 40 re-allocates the number of copies to the printers 30 which have normally performed the confirmation printing operation. For example, if the second printer 32 fails to perform normal confirmation printing, the distributed print control device 40 allocates the number of copies to the first printer 31 and third printer 33. If the number of copies is “9”, the distributed print control device 40 distributes the copy number by allocating five copies to the first printer 31, and four copies to the third printer 33.

If the Cancel button 104 has been operated on the setting screen shown in FIG. 2, conversion into the PDL data and transmission to the printer controller 20 will be suspended.

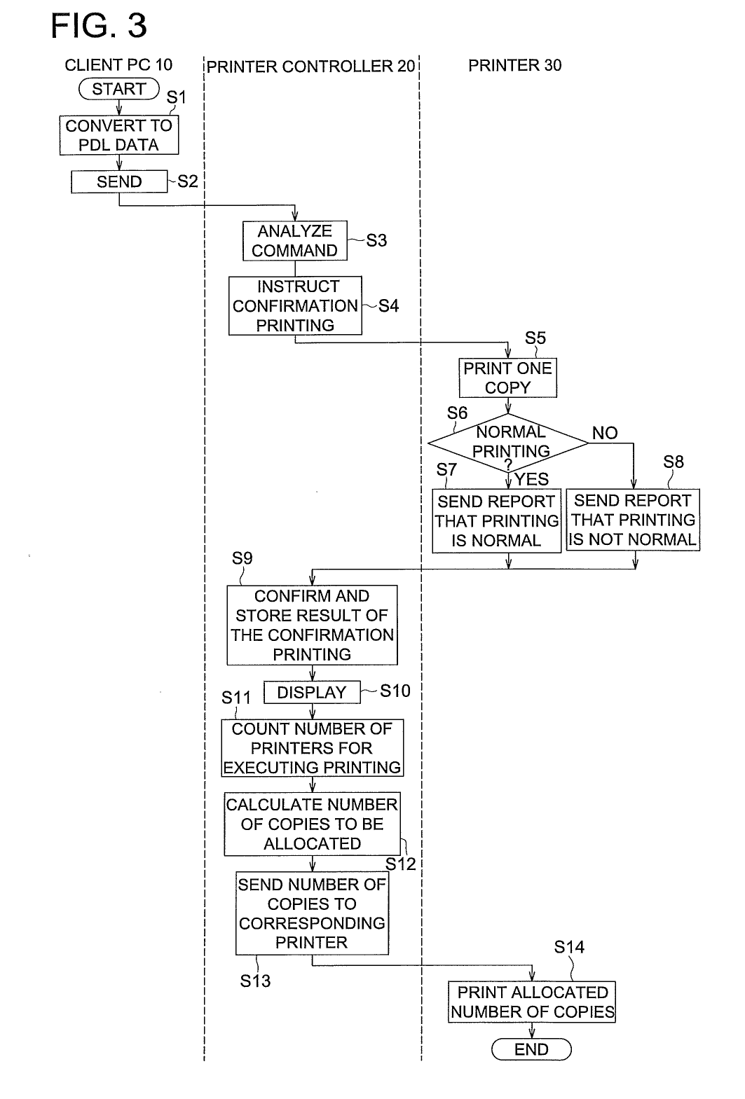

The following describes the image forming method of the present embodiment. First of all, the number of copies is inputted on the setting screen shown in FIG. 2, and instructions on distributed printing and confirmation printing are given. Then the OK button 103 is operated. Then the flow chart of FIG. 3 starts. FIG. 3 is a flow chart showing the image forming method in the first embodiment.

As shown in FIG. 3, the printer driver 13 of the client PC 10 converts into the PDL data, the information on the document and number of copies, as well as the information indicating that distributed printing instruction has been given and confirmation printing instruction has been given (S1). The client PC 10 sends the PDL data to the printer controller 20 through the network interface 14 (S2).

The processing section 23 of the printer controller 20 analyzes commands of the distributed printing and confirmation printing included in the PDL data (S3). The processing section 23 gives a confirmation printing instruction to each of the printers 30 (S4). This allows each of the printers 30 to print only one copy (S5). After that, the printer 30 is placed in the standby state.

Then the user goes to each of the printers 30, and checks the results of confirmation printing. The operation panels 31b through 33b contain the bottoms that receive the result as to whether or not confirmation printing has been performed normally. Thus, for example, if the confirmation printing operation has been performed normally by the first printer 31, the user inputs this information in the operation panel 31b of the first printer 31. This procedure allows the control section 31c of the first printer 31 to determine that the confirmation printing operation has been performed normally (S6: YES), and sends the information on the normal status of the confirmation printing to the printer controller 20 (S7).

On the other hand, if normal confirmation printing cannot be performed by the first printer 31, the user inputs information on this matter in the operation panel 31b of the first printer 31. This procedure allows the control section 31c of the first printer 31 to determine that confirmation printing cannot be performed normally (S6: NO), and sends the information that the confirmation printing was not normal to the printer controller 20 (S8). This procedure is also applied to other printers 32 and 33.

Then the distributed print control device 40 recognizes and stores the results of confirmation printing (S9). In this case, the distributed print control device 40 stores the results of confirmation printing in the HDD section 24 or other memory. The display section 26 of the printer controller 20 displays the result of confirmation printing (S10).

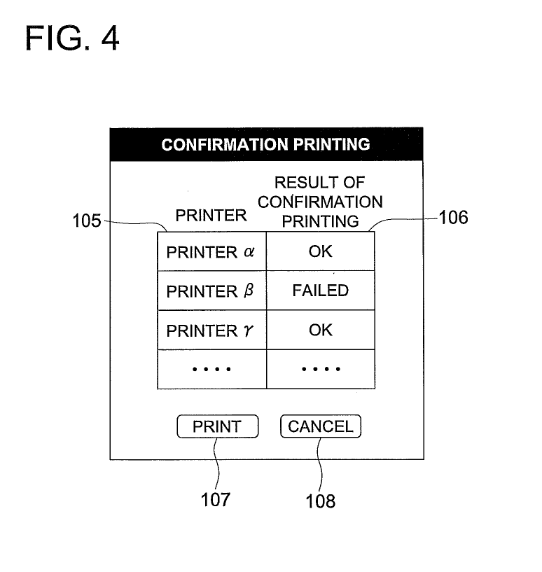

FIG. 4 is a diagram showing an example of display on the display section 26. As shown in FIG. 4, the display section 26 displays the item 105 representing the printer name, and the item 106 showing the result (“OK” or “FAIL”) of confirmation printing. These items permit the display section 26 to display a message about the printers 30 having received the operation notifying that the normal confirmation printing has been done. This procedure allows the user to make collective reference to the printers 30 having completed normal confirmation printing and having failed to perform normal confirmation printing, out of the plurality of printers 30.

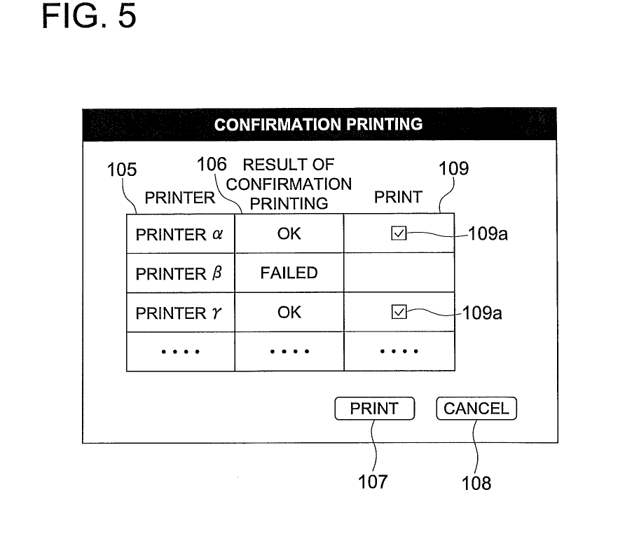

FIG. 5 is a diagram showing another example of display on the display section 26. As shown in FIG. 5, the display section 26 displays not only the item 105 representing the printer name, and the item 106 showing the result of confirmation printing, but also the selection item 109 that permits selection of the printer 30 to be used to perform distributed printing operation. To put it more specifically, the display section 26 shows the check box 109a for the printers 30 that have performed confirmation printing normally. By checking the check box 109a, the user can select the printers 30 to be used to perform distributed printing operation.

Again refer to FIG. 3. After the display shown in FIGS. 4 and 5, the distributed print control device 40 counts the printers to be operated for the printing (S11). As shown in FIG. 4, the printers 30 whose successful performance of confirmation printing has been inputted as information through the operation panels 31b through 33b are counted by the distributed print control device 40 as printers 30 to be operated for the printing. In the case of the example of FIG. 5, the printers 30 having been checked in the check box 109a are counted by the distributed print control device 40 as printers 30 to be operated for the printing.

After that, the distributed print control device 40 performs the calculation of allocation (S12) to determine the number of copies to be printed by each of the printers 30 counted in Step S11. To put it more specifically, when all the printers 30 have successfully performed confirmation printing operation, or when the check boxes 109a of all the printers 30 have been checked, and when six copies are specified, the distributed print control device 40 allocates two copies uniformly to each of the printers 30. When one printer 30 has failed to perform normal confirmation printing, or when all the printer 30 have performed normal confirmation printing but the check box 109a of one printer 30 has not been checked, and when printing of six copies is specified, the distributed print control device 40 allocates three copies uniformly to each of other printers.

To put it in more detail, the distributed print control device 40 allocates the number of copies according to the following calculation formula. Assuming that the number of all copies is “m”, and the number of counted printers 30 is “n”, the distributed print control device 40 allocates the number of copies to the counted printers 30 according to the calculation formula of m/n. If the m/n is “A.XYZ” (where A is an integer and XYZ is a number below decimal point) without being an integer, the distributed print control device 40 allocates “A+1” copies to at least any one of the counted printers 30, and allocates “A” copies to the other printers 30.

Without being restricted to the case of allocating the number of copies in the above-mentioned manner, the distributed print control device 40 is allowed to allocate the number of copies with consideration given to printing speed. To be more specific, the distributed print control device 40 can allocate the number of copies in such a way that the number of copies will be larger for the printers 30 having higher printing speed in the order of the speed. This arrangement ensures printing to be performed in conformance to the performance of each of the printers 30, and enhances printing efficiency.

After that, when the print button 107 shown in FIGS. 4 and 5 has been operated, the distributed print control device 40 gives an instruction on the number of copies calculated in Step S12 to the printers 30 counted in Step S11 (S13). Thus, the printers 30 for which printing has been specified, print out only the allocated number of copies (S14). This terminates the processing of FIG. 3. If the Cancel button 108 has been operated in the aforementioned processing steps, the distributed printing operation is suspended.

As described above, according to the image forming system 1 and image forming method in the first embodiment, a distributed print control device 40 is provided, in which as a result of confirmation printing, if at least one printer 30 has been determined to be unable to perform normal confirmation printing, a plurality of copies are distributed to the printers 30 having been determined to have performed normal confirmation printing, whereby distributed printing operation is performed. Thus, even if some of the printers 30 have failed to perform normal printing in the distributed printing mode, the number of copies to be printed is distributed to the printers 30 having performed normal confirmation printing. This arrangement provides the printed copies normally printed in the number required by the user.

Based on the information on the printing speed of each of the printers 30, the distributed print control device 40 can allocate the number of copies in such a way that the number of copies is larger for printers 30 having higher printing speed in the order of the speed. This arrangement ensures printing to be performed in conformance to the performance of each of the printers 30, and enhances printing efficiency.

A plurality of printers 30 are provided with the operation panels 31b through 33b that receive the operation of the user to indicate whether or not the confirmation printing has been performed normally. The printer controller 20 is equipped with the display section 26 for displaying to show that confirmation printing has been normal regarding the printers 30 having received an operation of the user on the operation panels 31b through 33b notifying that confirmation printing has been performed normally, and a print button 107 that conducts distributed printing which distributes printing operations of a plurality of number of copies to the printers 30 which have been displayed to have performed normal confirmation printing. Thus, just by viewing the display section 26, the user gets a tabulated list of the printers 30 to be operated for distributed printing. After checking, the user can start distributed printing operation.

A check box 109a is further provided to select the printers 30 to which a plurality of copies to be printed are distributed for performing distributed printing, out of the printers 30 whose normal confirmation printing operation is displayed on the display section 26. The distributed print control device 40 allocates printing of a plurality of copies to the printers 30 checked in the check box 109a, to perform distributed printing. Thus, not all the printers 30 having completed normal confirmation printing are used for distributed printing. The user is allowed to select the printers 30 to perform distributed printing. This arrangement enhances convenience.

In the initial status, the check box 109a has been checked for all the printers 30 which are displayed to have performed normal confirmation printing. Thus, if the user wishes the distributed printing to be performed by all the printers 30 having performed normal confirmation printing, the time of checking can be saved. This signifies more enhanced convenience.

The plurality of printers 30 are connected in a form of clustering connection, the distributed print control device 40 is incorporated in the printer controller. Thus, when the plurality of printers 30 are connected in a form of clustering connection, the number of copies desired by the user can be printed normally, even if normal printing cannot be performed by some of the printers 30.

The following describes the second embodiment of the present invention. The image forming system 2 of the second embodiment is the same as the first embodiment except for part of the processing. The following describes the differences from the first embodiment:

The image forming system 1 of the first embodiment displays the result of confirmation printing on the display section 26 of the printer controller 20 in Step S10. When the user has operated the print button 107, the relevant printers 30 start printing simultaneously. In the image forming system 2 of the second embodiment, when any one of the printers 30 completes normal confirmation printing, the user checks this performance. Then when the user inputs the information on the performance of normal printing in any one of the operation panels 31b through 33b, the printer 30 starts printing of the allocated number of copies. To be more specific, in the second embodiment, the printer 30 starts printing before the user operates the print button 107.

In the second embodiment, the printer 30 starts printing before the user operates the print button 107. Accordingly, if confirmation printing has failed in at least one printer 30, the calculation for allotment of the number of copies is different from that in the image forming system 1 of the first embodiment. To be more specific, in the second embodiment, the distributed print control device 40 receives the information on the number of copies already printed, from the printers 30 wherein normal confirmation printing was performed and printing has already started, and calculates the number of copies to be allocated, giving consideration to the received information.

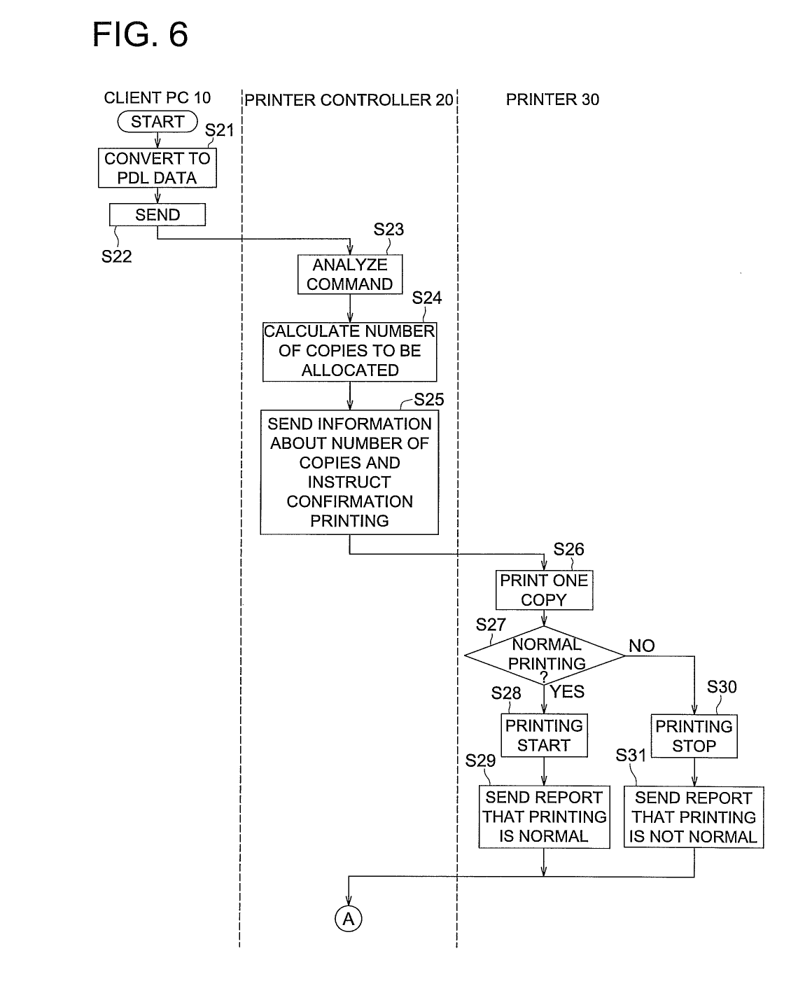

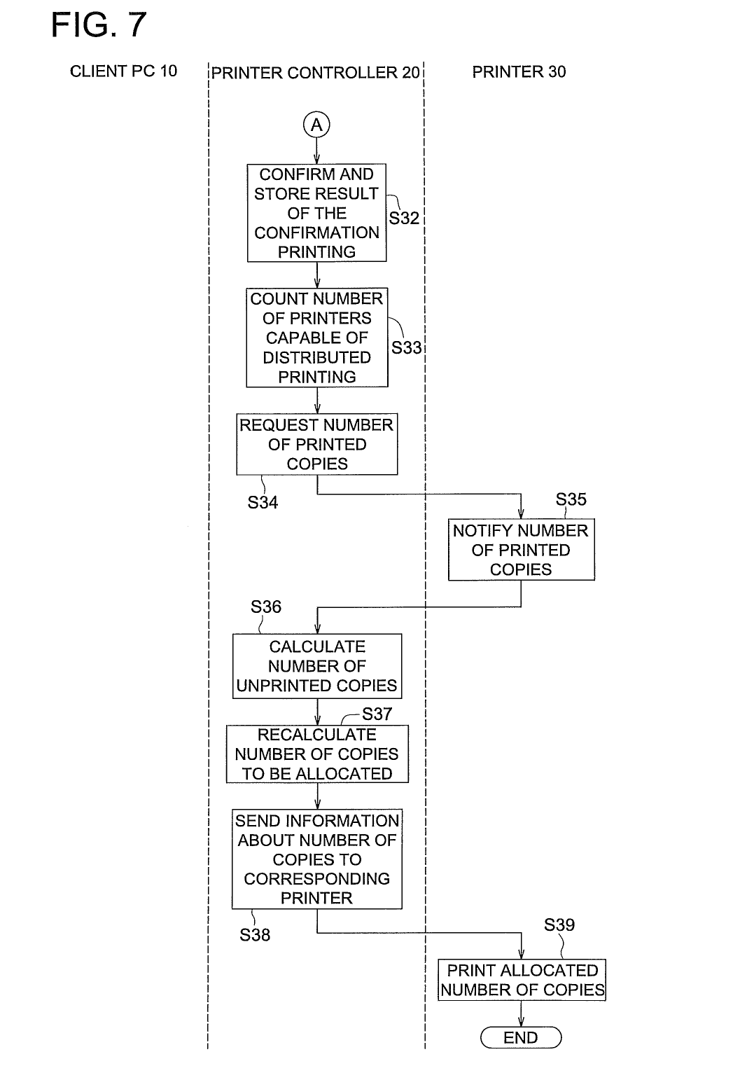

FIGS. 6 and 7 are the flow charts showing the image forming method of the second embodiment. At the start of the flow charts of FIGS. 6 and 7, the number of copies is inputted on the setting screen as illustrated in FIG. 2, and distributed printing and confirmation printing are specified. Then the OK button 103 is pressed. The procedures in Steps S21 through S23 of FIG. 6 are the same as those in Steps S1 through S3 of FIG. 3, and will not be described to avoid duplication.

After analyzing the distributed printing and confirmation printing commands contained in the PDL data in Step S23 of FIG. 6, the processing section 23 calculates the number of copies to be allocated for printing (S24). For example, when distributed printing of 300 copies is set on the setting screen of the printer driver 13, the processing section 23 allocates 100 copies to each of the three printers 30. The processing section 23 can distribute the number of copies with consideration given to the printing speed. After that, the printer controller 20 sends the information on the number of copies calculated in Step S24, and gives a confirmation printing instruction to each of the printers 30 (S25). This procedure allows each of the printers 30 to print only one copy (S26). Then each of the printers 30 is placed in the standby state.

After that, the user goes to each of the printers 30, and checks the result of confirmation printing. For example, if confirmation printing has been performed normally in the first printer 31, the user inputs this result in the operation panel 31b of the first printer 31. This allows the control section 31c of the first printer 31 to determine that the confirmation printing has been operated normally (S27: YES) and then printing starts (S28). At the same time, the control section 31c sends information on the normal status of the confirmation printing operation to the printer controller 20 (S29). To be more specific, the image forming system 2 of the second embodiment allows printing operation to be performed in the order of the printers 30, starting from the printer 30 on which information on the normal status of confirmation printing operation has been received first.

If the normal confirmation printing has failed in the first printer 31, the user inputs information on this matter in the operation panel 31b of the first printer 31. This arrangement allows the control section 31c of the first printer 31 to determine that the normal confirmation printing has failed (S27: NO), and suspends the printing operation (S30). At the same time, the control section 31c sends the information on the abnormal status of the confirmation printing to the printer controller 20 (S31). This statement also applies to the cases of printers 32 and 33.

As shown in FIG. 7, the distributed print control device 40 recognizes and stores the result of confirmation printing (S32). In this case, the distributed print control device 40 stores the result of confirmation printing in the HDD section 24 and other memories. In Steps S29 and S31, the distributed print control device 40 counts the printers for conducting printing, based on the information sent from each of the printers 30 (S33). To put it another way, the distributed print control device 40 counts the printers that have already started printing.

Then the distributed print control device 40 requests each of the printers 30 counted in Step S33 to provide information on the number of copies already printed (S34). In response to this request, the printers 30 send information on the number of copies having been printed, to the distributed print control device 40 (S35).

After that, the distributed print control device 40 calculates the remaining number of copies (S36). For example, when a total of 300 copies are to be printed in the distributed printing mode and assuming that the first printer 31 has already printed 90 copies, the third printer 33 has already printed 120 copies, and the second printer 32 cannot perform normal confirmation printing and its operation has been suspended, the distributed print control device 40 counts the remaining copies as ninety.

After that, the distributed print control device 40 re-calculates the number of copies to be allocated (S37). In this Step S37, the distributed print control device 40 calculates the number of remaining copies calculated in Step S36, for allocation. If the number of remaining copies is ninety and the operation of only the second printer 32 is not yet started, the distributed print control device 40 allocates 45 copies uniformly, for example, to each of the first printer 31 and the third printer 33. The distributed print control device 40 can also allocate the number of copies giving consideration to the printing speed.

After that, the distributed print control device 40 sends an instruction to the printer 30 having started printing to print the number of copies calculated in Step S37 (S38). Then the printer 30 having received the printing instruction adds the number of allocated copies, and performs additional printing (S39). This terminates the processing shown in FIGS. 6 and 7. In the processing shown in FIGS. 6 and 7, if normal confirmation printing has been performed by all the printers 30, processing in Steps S34 through S39 is omitted and the processing shown in FIGS. 6 and 7 terminates.

As described above, according to the image forming system 2 and image forming method of the second embodiment, normal printing can be performed to output the number of copies desired by the user, similarly to the case of the first embodiment. Further, printing is performed in conformance to the performance of each of the printers 30, whereby printing efficiency is enhanced.

Further, according to the second embodiment, when the information on the normal status of confirmation printing has been received on the operation panels 31b through 33b, printing operation is performed in the order of the printers 30, starting from the printer 30 on which information on the normal status of confirmation printing operation has been received first. Thus, the printers 30 having performed normal confirmation printing start printing immediately after the reception. This arrangement reduces the standby time and enhances the printing efficiency.

Further, the distributed print control device 40 receives the information on the number of copies having been printed, from the printer 30 that has already started printing. Based on the information on the number of copies having been printed, the distributed print control device 40 distributes the number of remaining copies. This allows the printing operation to be performed, with consideration given to the number of copies having been printed already, and further improves the printing efficiency.

The following describes the third embodiment. The image forming system 3 of the third embodiment is the same as that of the first embodiment, except for partial differences in structure and processing. The following describes the differences from the first embodiment.

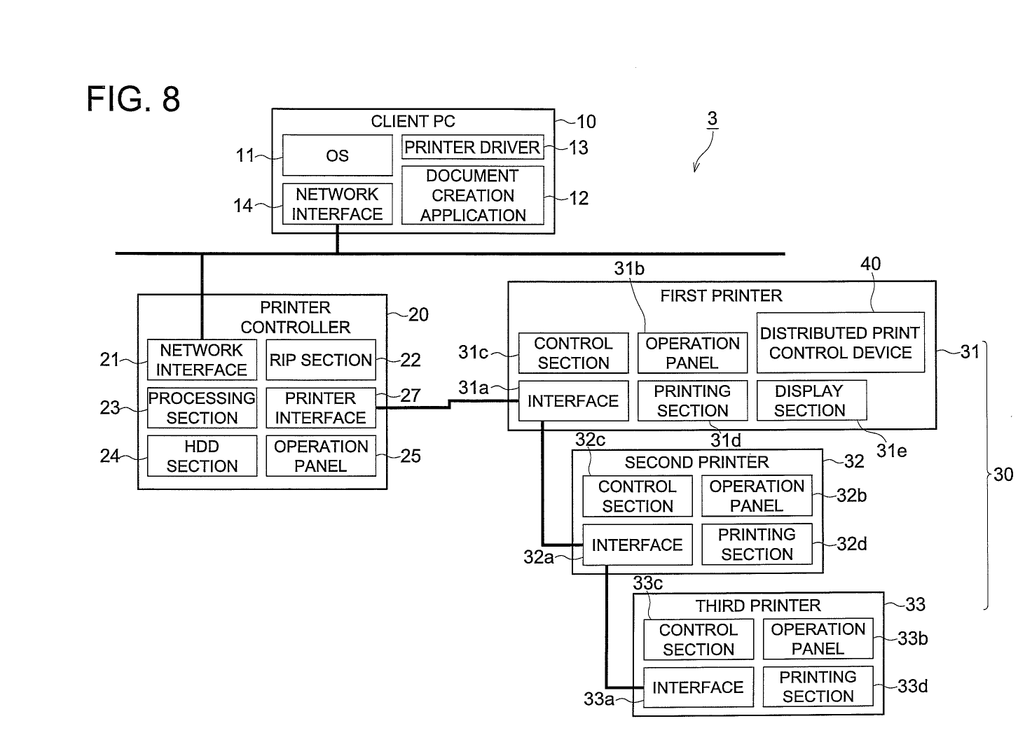

FIG. 8 is a control block diagram showing the overall structure of the image forming system 3 in the third embodiment. As shown in FIG. 8, a plurality of printers 30 have interfaces 31a through 33a, respectively. Through these interface 31a through 33a, a tandem connection, which is a serial connection, is established between the first printer 31 that is a parent machine, and the second and third printers 32 and 33. The distributed print control device 40 is installed inside the first printer 31 as a parent machine in the tandem connection. Further, the first printer 31 includes a display section 31e. In the third embodiment, a plurality of printers 30 are connected via the Intranet, however IEEE 1394 or Parallel connection method may be used for connection between the first printer 31 and second printer 32, and between the second printer 32 and the third printer 33.

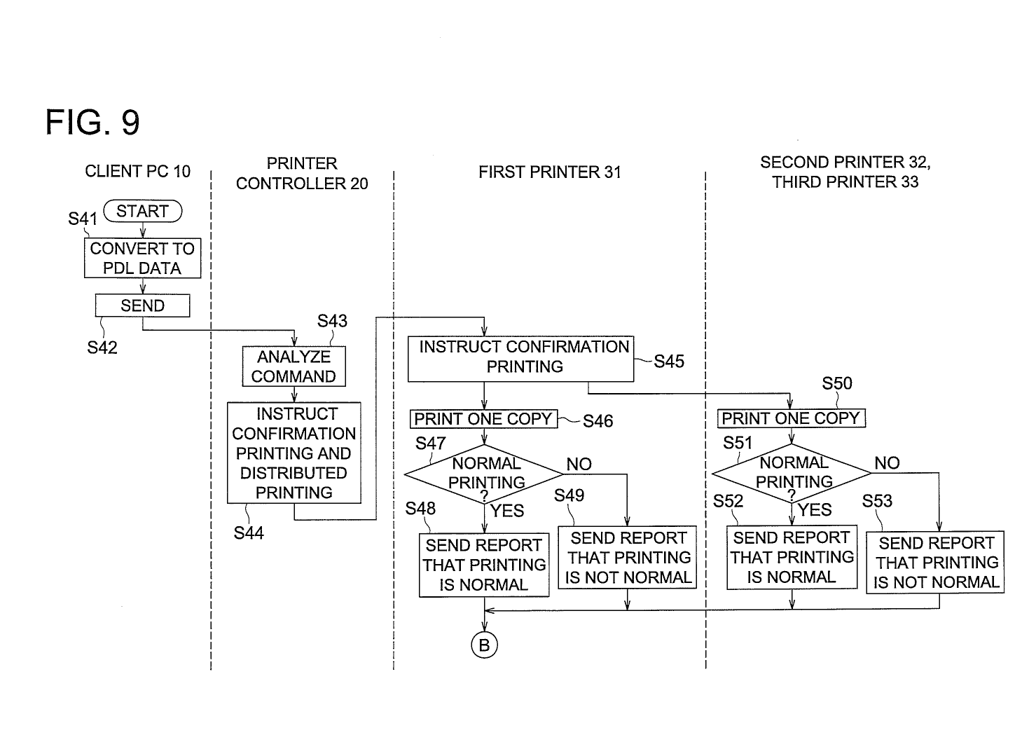

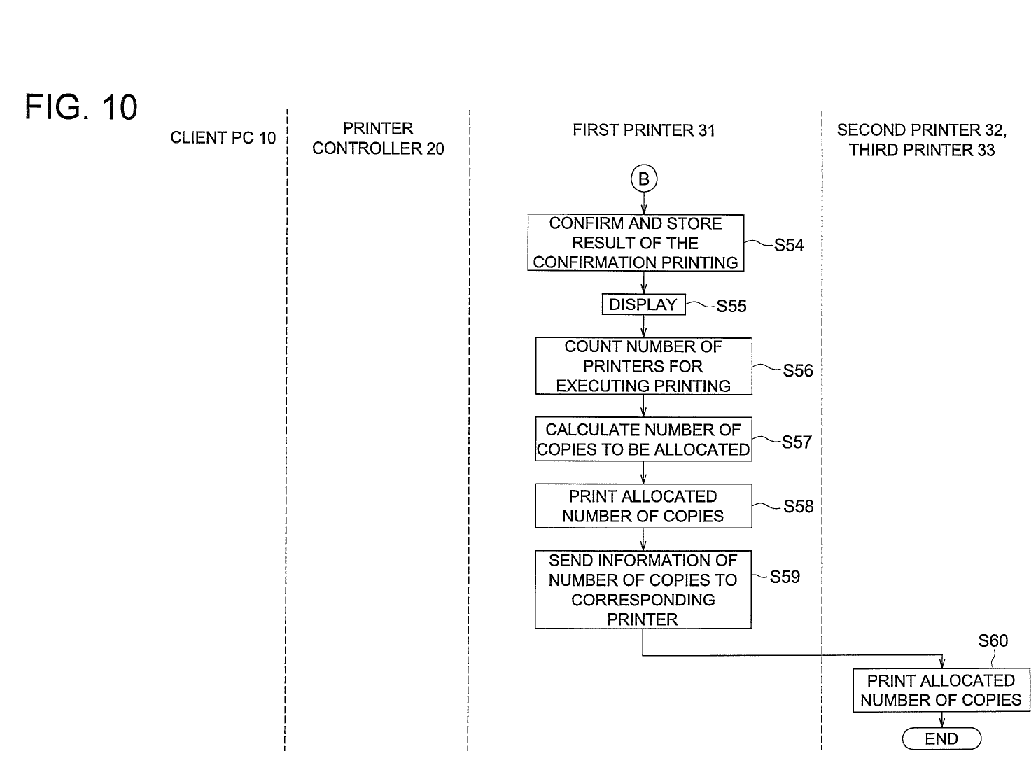

Since printers 30 are connected by tandem connection method, the image forming system 3 of the third embodiment performs the following operation. FIGS. 9 and 10 are the flow charts representing the image forming method of the third embodiment. Before the flow charts of FIGS. 9 and 10 start to work, it is assumed that the information on the number of copies is inputted on the setting screen shown in FIG. 2, and distributed printing and confirmation printing operations are specified. The OK button 103 is also assumed to have been operated. Processing of Steps S41 through S43 of FIG. 9 is the same as that of Steps S1 through S3 shown in FIG. 3, and will not be described to avoid duplication.

In Step S43 of FIG. 9, after analyzing the commands of distributed printing and confirmation printing included in the PDL data, the processing section 23 gives confirmation printing and distributed printing instructions to the first printer 31 (S44). Then the first printer 31 gives confirmation printing instructions to itself, and second and third printers 32 and 33 (S45). The first printer 31 prints only one copy (S46). After that, the first printer 31 is placed in the standby state.

Then the user goes to the first printer 31, and checks the results of confirmation printing. For example, if confirmation printing has been performed normally in this case, the user inputs this result in the operation panel 31b of the first printer 31. This allows the control section 31c of the first printer 31 to determine that the confirmation printing has been operated normally (S47: YES), and to send information on the normal status of the confirmation printing operation to the distributed print control device 40 (S48).

If confirmation printing cannot be performed normally in the first printer 31, the user inputs the abnormal status of the confirmation printing in the operation panel 31b of the first printer 31. This allows the control section 31c of the first printer 31 to determine that normal printing has failed (S47: NO), and to send the information on the abnormal status of the confirmation printing to the distributed print control device 40 (S49).

Further, upon receipt of the confirmation printing instruction in Step S45, the second and third printers 32 and 33 executes printing of only one copy (S50). After that, the second and third printers 32 and 33 are placed in the standby state.

Then the user goes to the second and third printers 32 and 33, and checks the results of confirmation printing. For example, if the confirmation printing has been performed normally in this case, the user inputs this result in the operation panels 32b and 33b of the second and third printers 32 and 33. This allows the control sections 32c and 33c of the second and third printers 32 and 33 to determine that the printing has been operated normally (S51: YES), and to send information on the normal status of the confirmation printing operation to the distributed print control device 40 (S52).

If confirmation printing cannot be performed normally in the second and third printers 32 and 33, the user inputs the abnormal status of the confirmation printing in the operation panels 32b and 33b of the second and third printers 32 and 33. This allows the control sections 32c and 33c of the second and third printers 32 and 33 to determine that normal printing has failed (S51: NO), and to send the information on the abnormal status of the confirmation printing to the distributed print control device 40 (S53).

As shown in FIG. 10, the distributed print control device 40 recognizes and stores the result of confirmation printing (S54). The display section 31e of the first printer 31 displays the result of confirmation printing (S55), as shown in FIG. 4 or 5.

After that, the distributed print control device 40 counts the printers to be used to perform printing operation (S56). The distributed print control device 40 calculates the number of copies to be allocated to each of the printers 30 counted in Step S56 (S57). In this processing, the distributed print control device 40 can allocate the number of copies uniformly to the printers 30 having been counted, or can allocate the number by taking the printing speed into account.

After that, when the print button 107 shown in FIGS. 4 and 5 has been operated, the first printer 31 prints out only the number of copies allocated thereto (S58). Further, the distributed print control device 40 gives a printing instruction to the printer or printers 30 to be operated for distributed printing, out of the second and third printers 32 and 33, and sends the information on the number of copies (S59). Thus, the printers 30 having received the printing instruction prints out only the number of copies having been allocated (S60). Then the processing shown in FIGS. 9 and 10 terminates. If the Cancel button 108 has been operated during the aforementioned steps of processing, the distributed printing is suspended. Further, if the confirmation printing of the first printer 31 has failed in the aforementioned steps of processing, processing in Step S58 will be omitted.

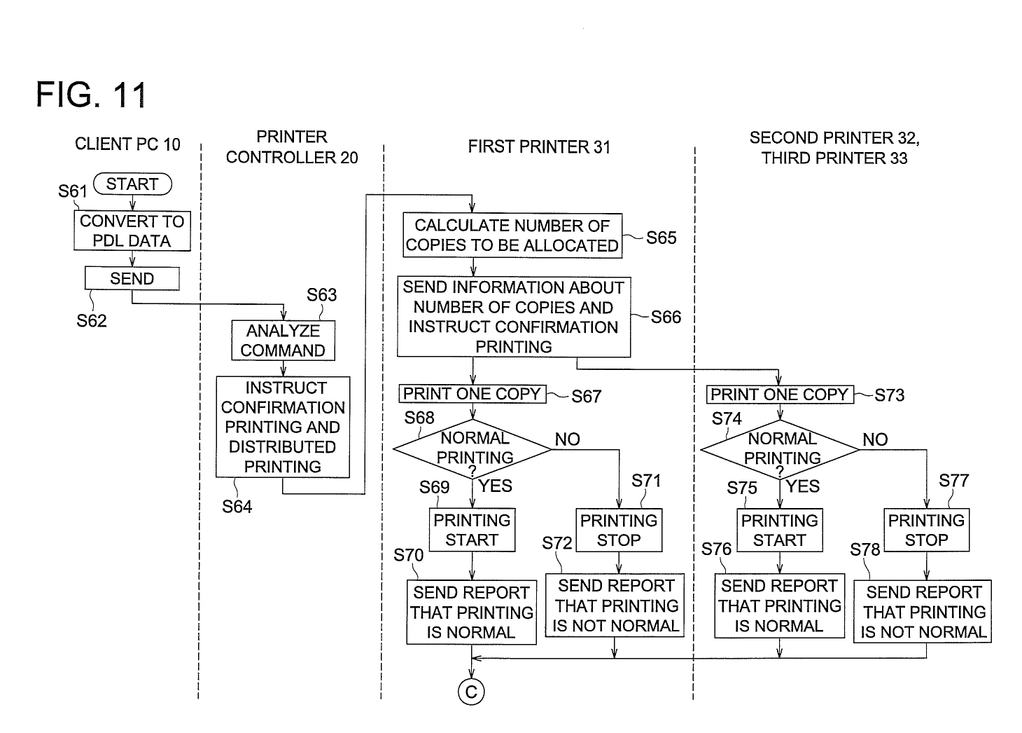

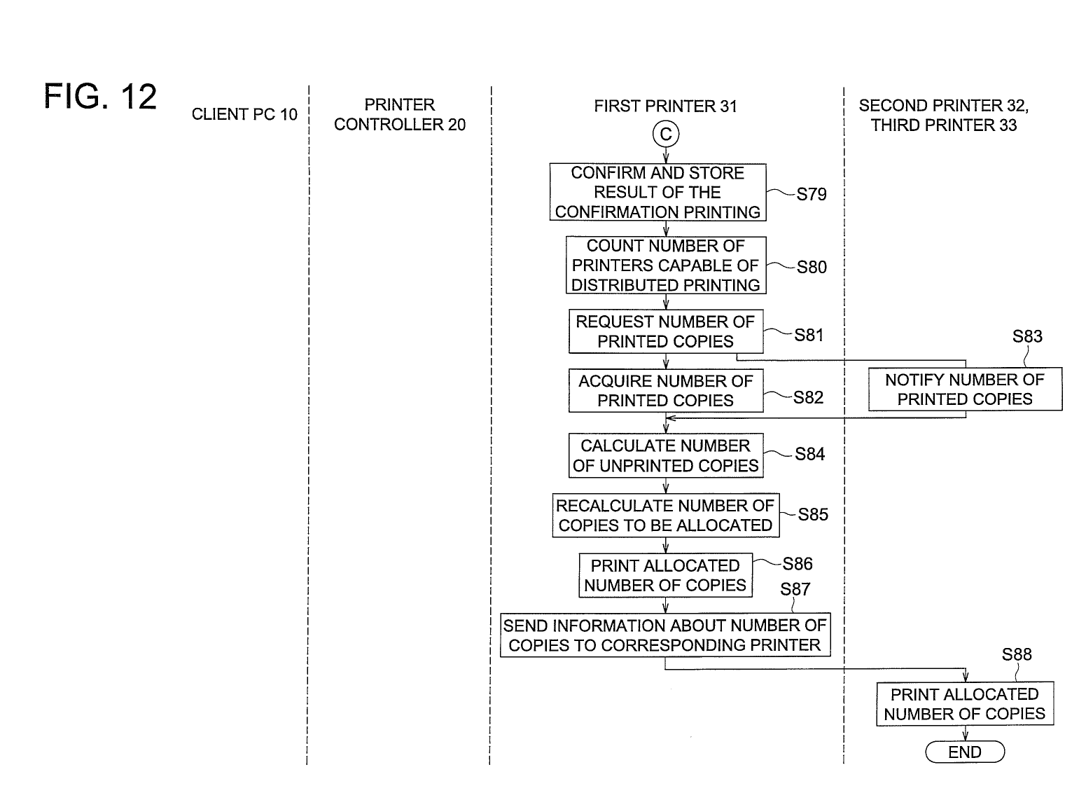

The image forming system 3 of the third embodiment can start printing operation before the user operates the print button 107, as the same as in the case of the image forming system 2 shown in the second embodiment. FIGS. 11 and 12 are flow charts representing another example of the image forming method in the third embodiment. Before the flow charts of FIGS. 11 and 12 start to work, it is assumed that the number of copies has been inputted on the setting screen shown in FIG. 2, and distributed printing and confirmation printing operations have been specified. Also it is assumed that the OK button 103 has been operated. Processing in Steps S61 through S63 of FIG. 11 is the same as that in Steps S21 through S23 of FIG. 6, and will not be described to avoid duplication.

In Step S63 of FIG. 11, after analyzing the distributed printing and confirmation printing commands contained in the PDL data, the processing section 23 gives distributed printing and confirmation printing instructions to the first printer 31 (S64). Then the processing section 23 calculates the number of copies to be allocated (S65).

Then the control section 31c of the first printer 31 sends to the first printer 31 the information on the number of copies calculated in Step S65. Further, the control section 31c of the first printer 31 gives a confirmation printing instruction to itself, and second and third printers 32 and 33 (S66). This allows the first printer 31 to print only one copy first (S67). Then the first printer 31 is placed in the standby state.

After that, the user goes to the first printer 31, and checks the result of confirmation printing. For example, if confirmation printing has been performed normally in the first printer 31, the user inputs this result in the operation panel 31b of the first printer 31. This allows the control section 31c of the first printer 31 to determine that the confirmation printing has been operated normally (S68: YES) and then printing starts (S69). At the same time, the control section 31c sends information on the normal status of the confirmation printing operation to the distributed print control device 40 (S70).

If the normal confirmation printing has failed in the first printer 31, the user inputs this information in the operation panel 31b of the first printer 31. This arrangement allows the control section 31c of the first printer 31 to determine that the normal confirmation printing has failed (S68: NO), and suspends the printing operation (S71). At the same time, the control section 31c sends the information on the abnormal status of the confirmation printing to the printer controller 20 (S72).

Upon receipt of the confirmation printing instruction in Step S66, each of the second and third printers 32 and 33 prints only one copy (S73). After that, the second and third printers 32 and 33 are placed in the standby state.

Then the user goes to the second and third printers 32 and 33, and checks the result of confirmation printing. For example, if confirmation printing has been performed normally in this case, the user inputs this result in each of the operation panels 32b and 33b of the second and third printers 32 and 33. This allows the control sections 32c and 33c of the second and third printers 32 and 33 to determine that the confirmation printing has been operated normally (S74: YES) and then printing starts (S75). At the same time, the control sections 32c and 33c send the information on the normal status of the confirmation printing operation to the distributed print control device 40 (S76).

If the normal confirmation printing has failed in the second and third printers 32 and 33, the user inputs this information in the operation panels 32b and 33b of the second and third printers 32 and 33. This arrangement allows the control sections 32c and 33c of the second and third printers 32 and 33 to determine that the normal confirmation printing has failed (S74: NO), and suspends the printing operation (S77). At the same time, the control sections 32c and 33c send the information on the abnormal status of the confirmation printing to the distributed print control device 40 (S78).

As shown in FIG. 12, the distributed print control device 40 recognizes and stores the result of confirmation printing (S79). Based on the information sent from each of the printers 30, the distributed print control device 40 counts the printers to be operated for the printing (S80). To put it another way, the distributed print control device 40 counts the printers already having started printing operation.

Then the distributed print control device 40 requests each of the printers 30 having been counted in Step S80 to provide the information on the number of copies having been printed (S81). In response to this request, the printer 30 having been requested provides the distributed print control device 40 with the information on the number of copies having been printed (S82 and S83).

After that, the distributed print control device 40 calculates the number of remaining copies (S84). Then the distributed print control device 40 recalculates the number of copies to be allocated (S85). The first printer 31 prints out only the allocated number of copies to itself (S86). Further, the distributed print control device 40 gives a printing instruction to the printer or printers 30 to be operated for distributed printing, out of the second and third printers 32 and 33, and sends the information on the number of copies (S87). Then the printer 30 provided with printing instruction prints out only the allocated number of copies (S88). After that, the processing of FIGS. 11 and 12 terminates. If the results of confirmation printing of all the printers 30 have been normal in the aforementioned step of processing, processing of Steps S81 through S88 is omitted, and the processing of FIGS. 11 and 12 terminates. If the confirmation printing of the first printer 31 has failed in the aforementioned step of processing, the processing of Step S86 will be omitted,

As described above, according to the image forming system 3 and image forming method of the third embodiment, a desired number of copies by the user can be printed normally, similarly to the case of the first embodiment. Further, printing efficiency is improved, and at the same time the user can collectively verify all the printers 30 for distributed printing by checking the display section 31e. Distributed printing operation can be started after verification.

The printers 30 to be operated for distributed printing can be selected by the user. This arrangement enhances convenience and saves the time and effort for checking, whereby further improvement of convenience can be achieved.

Similarly to the case of the second embodiment, the printers 30 having performed normal confirmation printing start printing immediately after the operation. This reduces the standby time and enhances the printing efficiency. Further, the number of copies having been printed can be taken into account when printing is performed. This contributes to further improvement of printing efficiency.

According to the third embodiment, a plurality of printers 30 are connected in tandem, and the distributed print control device 40 is installed inside the first printer 31 which is a parent device. Thus, when a plurality of printers 30 are connected in tandem, a desired number of copies by the user can be printed normally, even if normal printing operation cannot be performed in some of the printers 30.

The following describes the fourth embodiment of the present invention: The image forming system 4 of the fourth embodiment is the same as that of the first embodiment, except for some differences in structure and processing. The following describes the differences from the first embodiment.

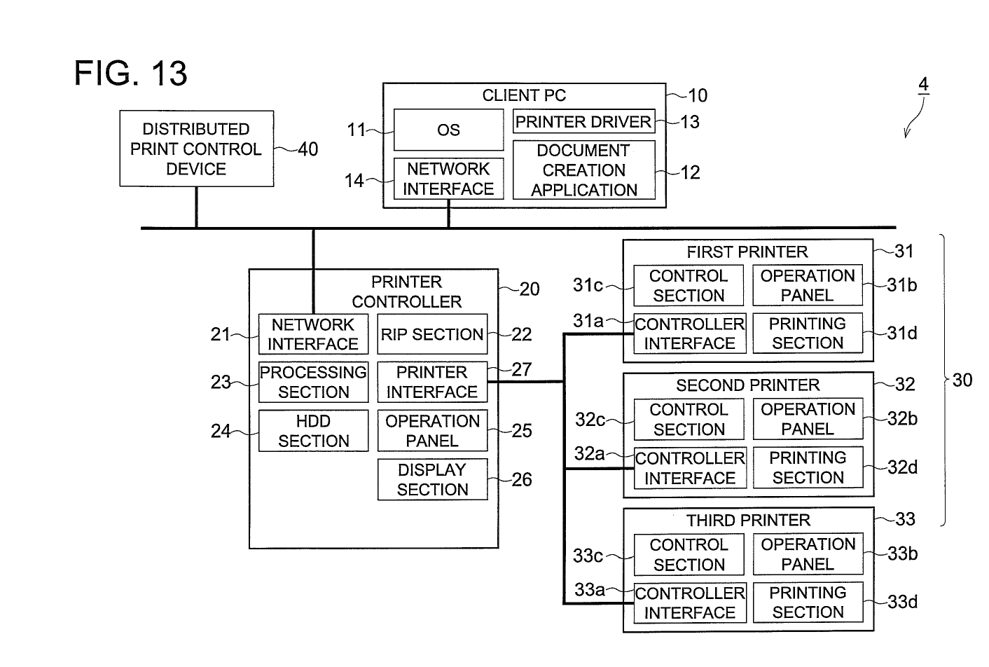

FIG. 13 is a control block diagram showing the overall structure of the image forming system 4 in the fourth embodiment. As shown in FIG. 13, the distributed print control device 40 is a server provided over the network. Thus, when normal confirmation printing has failed in at least one of the printers 30, the distributed print control device 40 of the fourth embodiment calculates the number of copies to be allocated. After that, the distributed print control device 40 gives an instruction to the printer controller 20 to send the information on the number of copies to the relevant printer 30.

Processing of the image forming system 4 in the fourth embodiment is the same as that of FIG. 3. In the fourth embodiment, processing performed by the distributed print control device 40 in the flow chart of FIG. 3 is executed via the printer controller 20.

Similarly to the case of processing of FIGS. 6 and 7 in the second embodiment, the image forming system 4 of the fourth embodiment can start printing before the user operates the print button 107, or can be applied in the case of tandem connection, as described in the third embodiment.

As described above, according to the image forming system 4 and image forming method of the fourth embodiment, a desired number of copies by the user can be printed normally, similarly to the case of the first embodiment. Further, printing efficiency is improved, and at the same time the user can collectively verify all the printers 30 for distributed printing by checking the display section 26. The distributed printing operation can be started after verification.

The printers 30 to be operated for distributed printing can be selected by the user. This arrangement enhances convenience and saves the time and effort for checking, whereby further improvement of convenience can be achieved.

Similarly to the case of the second embodiment, the printers 30 having performed normal confirmation printing start printing immediately after the operation. This reduces the standby time and enhances the printing efficiency. Further, the number of copies having been printed can be taken into account when printing is performed. This contributes to further improvement of printing efficiency.

According to the fourth embodiment, the distributed print control device 40 is a server provided over the network. Thus, independently of whether a plurality of printers 30 are connected in the manner of clustering or in tandem, the desired number of copies by the user can be printed, even if normal printing operation cannot be performed in some of the printers 30 in both cases.

The image forming system and image forming method of the present invention have been described with reference to embodiments. It is to be expressly understood, however, that the present invention is not restricted thereto. The present invention can be embodied in a great number of variations with appropriate modification or additions, without departing from the technological spirit.

For example, in the aforementioned embodiments, a printer 30 has been described as an example of the image forming apparatus. Without the present invention being restricted thereto, other image forming apparatuses such as a multi-functional peripheral can be used. Further, in the aforementioned embodiments, the distributed print control device 40 is located only inside the printer controller 20 and the first printer 31, and over the network. It goes without saying that the distributed print control device 40 can be installed at other places. In the above examples, furthermore, the display sections 26 and 31e are installed on the printer controller 20 or the first printer 31. Without the present invention being restricted thereto, it goes without saying that the display sections 26 and 31e can be installed in other places such as on the client PC or distributed print control device 40.

According to the image forming system and image forming method of the present invention, even if an image of normal quality cannot be obtained in the distributed printing mode in some of the image forming apparatuses, the desired number of copies of normal image quality by the user can be printed.

What is claimed is:

1. An image forming system which performs distributed printing in which a plurality of copies of printed matters are produced by assigning the plurality of copies to a plurality of image forming apparatuses, the image forming system comprising:
a distributed print control device which assigns the plurality of copies to one or more image forming apparatuses which have conducted confirmation printing normally among the plurality of image forming apparatuses so as to perform the distributed printing, when the confirmation printing was not able to be conducted normally on at least one of the plurality of image forming apparatuses as a result of confirmation printing conducted for confirmation of image quality on each of the plurality of image forming apparatuses which are candidates to which the plurality of copies are to be assigned.

2. The image forming system of claim 1,
wherein, based on printing speed of each of the one or more image forming apparatuses which have completed the confirmation printing normally, the distributed print control device assigns the plurality of copies to the one or more image forming apparatuses in such a way as to assign more copies to a faster image forming apparatus in printing speed, in order of the speed.

3. The image forming system of claim 1,
wherein each of the plurality of image forming apparatuses comprises:
an operation section which receives an operation of a user indicating whether or not the confirmation printing has been conducted normally, and
wherein the image forming system further comprises:
a display section which displays to indicate that the confirmation printing was normal for an image forming apparatus which has received, by the operation section, the operation of a user indicating that the confirmation printing has been conducted normally; and
a distributed print instructing section which conducts distributed printing by assigning the plurality of copies to one or more image forming apparatuses whose confirmation printing is indicated to be normal.

4. The image forming system of claim 3, further comprising:
a selecting section for selecting one or more image forming apparatuses to which the plurality of copies are to be assigned so as to conduct distributed printing among the one or more image forming apparatuses whose normality of the confirmation printing is displayed on the display section,
wherein the distributed print control device assigns the plurality of copies to the one or more image forming apparatuses selected by the selecting section so as to conduct distributed printing.

5. The image forming system of claim 4,
wherein the selecting section is in a situation where the selecting section has selected all the one or more image forming apparatuses whose normality of the confirmation printing is displayed on the display section, at a first stage.

6. The image forming system of claim 1,
wherein each of the plurality of image forming apparatuses comprises:
an operation section which receives an operation of a user indicating whether or not the confirmation printing has been conducted normally,
wherein when the operation section receives the operation indicating that the confirmation printing has been conducted normally, the system starts printing on an image forming apparatus in order of reception of the operation indicating that the confirmation printing was normal.

7. The image forming system of claim 6,
wherein the distributed print control apparatus receives information on a number of copies already printed, from the image forming apparatus which has already started printing, and based on the number of printed copies, the system distributes copies of a remaining number to the one or more image forming apparatuses which received the operation indicating that the confirmation printing has been conducted normally.

8. The image forming system of claim 1,
wherein the plurality of image forming apparatuses are connected in a clustering structure having a parallel connection relationship with each other and
wherein the distributed print control device is included in the printer controller which gives a printing instruction to each of the plurality of image forming apparatuses connected in the clustering structure.

9. The image forming system of claim 1,
wherein the plurality of image forming apparatuses are connected in tandem in which an image forming apparatus to be a parent apparatus and another or other image forming apparatuses are connected in series and
wherein the distributed print control device is included in the image forming apparatus to be the parent apparatus connected in tandem.

10. The image forming system of claim 1,
wherein the distributed print control device is a server provided on a network.

11. An image forming method comprising:
conducting confirmation printing for confirmation of image quality on each of a plurality of image forming apparatuses which are candidates to which a plurality of copies of printed matters are to be assigned; and
controlling distributed printing so as to assign the plural copies to one or more image forming apparatuses which have completed the confirmation printing normally among the plurality of image forming apparatuses, when the confirmation printing was not able to be conducted normally on at least one of the plurality of image forming apparatuses.

12. The image forming method of claim 11,
wherein the step of controlling distributed printing comprises:
assigning the plurality of copies to the one or more image forming apparatuses which have completed the confirmation printing normally in such a way as to assign more copies to faster image forming apparatus in printing speed, in order of the speed, based on the printing speed of each of the one or more image forming apparatuses.

13. The image forming method of claim 11, further comprises:
receiving, on each of the plurality of image forming apparatuses, an operation of a user indicating whether or not the confirmation printing has been conducted normally;
displaying to indicate that the confirmation printing was normal for an image forming apparatus which has received the operation indicating that the confirmation printing has been conducted normally, in the receiving step; and
conducting distributed printing by assigning the plurality of copies to one or more image forming apparatuses whose confirmation printing is indicated to be normal.

14. The image forming method of claim 13, further comprising:
selecting one or more image forming apparatuses to which the plurality of copies are to be assigned so as to conduct distributed printing among the one or more image forming apparatuses whose normality of the confirmation printing is displayed in the displaying step,
wherein the step of controlling distributed printing comprises:
conducting distributed printing by assigning the plurality of copies to the one or more image forming apparatuses selected in the selecting step.

15. The image forming method of claim 14,
wherein at a first stage of the selecting step, it is preset such that all the one or more image forming apparatuses whose normality of the confirmation printing is displayed in the displaying step have been selected.

16. The image forming method of claim 11, further comprising:
receiving, on each of the plurality of image forming apparatuses, an operation of a user indicating whether or not the confirmation printing has been conducted normally; and
starting printing on an image forming apparatus in order of reception of the operation indicating that the confirmation printing has been conducted normally when the operation indicating the normality of the confirmation printing is received in the receiving step.

17. The image forming method of claim 16,
wherein the step of controlling distributed printing comprises:
receiving information on a number of copies already printed, from the image forming apparatus which has already started printing; and
distributing copies of a remaining number, based on the number of printed copies, to the one or more image forming apparatuses which have received the operation indicating that the confirmation printing has been conducted normally.
